(19) United States
(12) Patent Application Publication
(10) Pub. No.: US 2022/0188526 A1
(43) Pub. Date: Jun. 16, 2022

(54) TRANSLATION DEVICE AND METHOD FOR THE HEARING IMPAIRED

(71) Applicant: Kimberly N. Incle, Las Vegas, NV (US)

(72) Inventor: Kimberly N. Incle, Las Vegas, NV (US)

(21) Appl. No.: 17/124,130

(22) Filed: Dec. 16, 2020

(51) Int. Cl. G06F 40/58; G06F 3/0484; H04W 4/021; G06Q 30/06; G06F 9/451; G06F 16/9537; G09B 21/00

(52) U.S. Cl. CPC G06F 40/58; G06F 3/04842; H04W 4/021; G06Q 30/0639; G08B 7/00; G06Q 30/0619; G06F 9/454; G06F 16/9537; G09B 21/009; G06Q 30/0625

(57) ABSTRACT

Provided is a multi-functional translation software for the deaf community and/or hard of hearing people. The platform is comprised of a software application installable on a smartphone or other electronic device. Users can input text in one language, allowing it to be translated via an internal translation service into a second language. The software application will automatically connect with a business once within range of the business allowing the customer and the business to communicate via text chat on the software application.

### BACKGROUND OF THE INVENTION

### 1. Field of the Invention

The present invention generally relates to portable communication systems. More specifically, the invention relates to a portable communication method and device which provides translation services with an emphasis on the deaf or hard of hearing.

### 2. Description of the Prior Art

Individuals who cannot speak or hear, or individuals who are unable to verbalize communication in the language at hand, experience difficulties in performing everyday tasks such as communicating with retail clerks, law enforcement officials, and the like. This communication barrier is, to a degree, addressed by many electronic devices and accompanying software. Particularly, with the advent of smartphones, hearing impaired individuals have a few options at their disposal for communicating with the general public, most of whom do not know sign language and are otherwise incapable of communicating with the hearing impaired.

In certain social situations, particularly those involving family or friends, the hearing impaired are able to communicate via, e.g., sign language or lip reading. However, particular difficulties arise when in certain business or commercial settings, as most e.g., retail clerks or professionals are simply not set up or trained to deal with the hearing impaired. This results in many uncomfortable scenarios where the hearing impaired individual must first attempt to communicate the fact he/she is hearing impaired, and then attempt to use whatever translation means they have at their disposal (if any) to communicate.

Accordingly, it would be desirable to provide a translation service for the hearing impaired that has particular utility in a commercial/business setting.

### SUMMARY OF THE INVENTION

Provided is a multi-functional translation software for the deaf community and/or hard of hearing people. The platform is comprised of a software application installable on a smartphone or other electronic device. The software application will automatically connect with a business once within range of the business allowing the customer and the business to communicate via text chat on the software application. Users can input text in one language, allowing it to be translated via an internal translation service into a second language to be received by the business.

The translation service may comprise a local or remote computing device executing translation software or a human translator. The translation service may produce an output which may comprise one or more of a written machine translation, an audible machine translation, a written human translation, an audible human translation or any combination thereof. The one or more commands may comprise any media format including text, audio, video and the like and may relate to interactions between customers and businesses. Users can communicate in a commercial setting with ease.

Further, a translation services platform is provided. The platform comprises a first user electronic device in wireless communication with a second user electronic device (associated with a particular business or commercial entity), where such communication may be initiated based upon a threshold proximity being met. The first user device comprises a graphical user interface by which a first user may input one or more commands in a first language which may be translated via a translation service into a second language which is subsequently communicated to a second user via a graphical user interface of the second user electronic device. The translation service may comprise a local or remote computing device executing translation software and/or a human translator. The translation service may produce an output which may comprise one or more of a written machine translation, an audible machine translation, a written human translation, an audible human translation or any combination thereof. The one or more commands may comprise any media format including text, audio, video and the like and may relate to interactions between customer and business, foreigner and local, disabled persons and non-disabled persons and the like. In one example, a deaf customer communicates with a business by way of respective electronic devices coming within a threshold proximity relative one another, thereby notifying the business that the customer is deaf. The deaf customer may place an order via a customer graphical user interface, the order received by the business via graphical user interface, all without requiring the deaf customer to write down their order.

It is a major object of the invention to provide an improved communication system having the ability to translate one language or form of communication to another.

It is another object of the invention to provide an improved communication method and device for the deaf or hard of hearing.

It is another object of the invention to provide an improved communication method and device which is proximity based.

It is another object of the invention to provide an improved communication method and device that can translate from one form of communication to another.

It is another object of the invention to provide an improved communication method and device that has particular utility in a commercial or business setting.

### BRIEF DESCRIPTION OF THE DRAWINGS

FIG. 1 shows a front plan view of a smartphone that can be used to perform the method of the invention.

FIG. 2 shows a graphical illustration of the environment of the inventive method and devices.

### DETAILED DESCRIPTION OF THE PREFERRED EMBODIMENTS

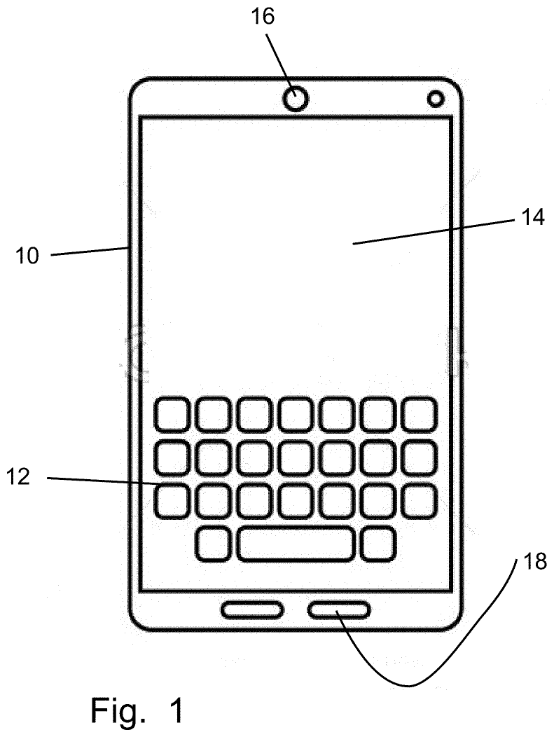

Referring now to FIG. 1, illustrated therein is a portable electronic telecommunication device embodied as a smartphone 10 which has an application for effecting the method of the invention stored thereon. The application would include text-to-speech and speech-to-text capabilities so that it can be used by a hearing-impaired user. The smartphone 10 includes a selectively displayable keypad 12, which keypad is generated in response to initiation of the text application and composed of alphanumeric GUIs arranged in a standard QWERTY format. The smartphone has a graphic display 14 that can display alphanumeric text and other graphics to the user of the smartphone 10 as well as others who can view the display 14. The smartphone 10 further has one or more speaker apertures 16 that provide audio access to a speaker which is typically placed next to the user's ear during conversation, and a microphone aperture 18 which provides audio access to a microphone such that the user can speak into the aperture 18 and the microphone converts the speech into electronic signals for transmission from the smartphone 10.

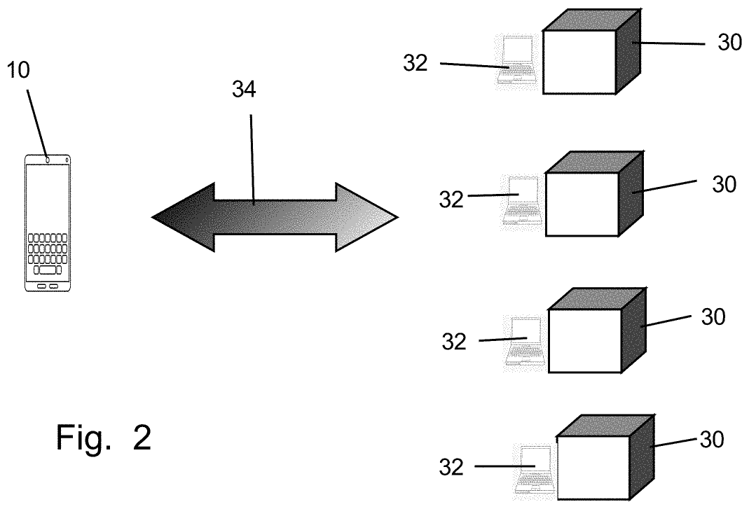

A key aspect of the invention is that the inventive application is proximity based. This proximity based capability can be implemented by the inventive application on any smartphone or other device having GPS capability. The desired proximity is predetermined by the application and may vary depending upon the business, the mode of transportation of the user, and the particular transaction. In a preferred embodiment, the user can optionally set parameters associated with the proximity aspect of the invention such as distance from the business 30, type of business 30 from which to receive prompts, etc. If the user does not set parameters, the predetermined distance will be determined by the inventive application. The application is in search mode whenever running and need not be initiated by the user. Of course, the application can be activated or deactivated by the user when desired. For example, if the business 30 will need processing time to prepare, e.g., a food order, the proximity may be one mile for a user in a vehicle, or 3 blocks for a user on foot. Algorithms for determining the predetermined distance would be a part of the downloaded application, these algorithms being applied as a default. With particular reference to FIG. 2, an environment in which the inventive method may be used is shown. In this scenario a user with a smartphone 10 is in proximity to several local businesses 30, with the addresses of all participating businesses 30 downloaded when the text application on the smartphone 10 is downloaded. Of course, new addresses will be downloaded when the user moves to a different, e.g., city or travels, these addresses becoming the new local business addresses.

Each business 30 has at least one computing device or resource 32 associated therewith, and each computing resource 32 is preloaded with the text/translation application software of the invention so that commands and instructions between smartphone 10 and computing device 32 are conducted using the same protocols. Preferably, the application software of the invention is installed as a subroutine to the existing software application for e.g., placing orders with the business online. The computing resource 32 can be as simple as another smartphone, or could be a laptop or server which interfaces with one or more smartphones or similar handheld devices operated by the business. Communication between the smartphone 10 and computing resource 32 is facilitated via the interne 34 or other communication network such as a LAN. If the user is heading to a particular business 30 in order to execute a specific transaction, he may optionally input (or otherwise indicate) the address of the business 30 using the application stored on smartphone 10, and place an order when ready. This may be done prior to heading to the business 30 to complete the transaction. Otherwise, in accordance with a key aspect of the invention, computing resource 32 associated with a business will “sense” or otherwise determine when a participating user is within the predetermined proximity. Determining when authorized users are within the predetermined proximity may be done using several methods familiar to those of skill in the art. For example, the phone 10 of each user can, using GPS data, send a text to (or otherwise interface with computing device 32) a business 30 when in the predetermined area. Once the user is in route and within proximity to the business 30, the application on smartphone 10 is activated and prompts the user audibly, visually or both (in the case of a hearing impaired or deaf person the prompt would be primarily visual or tactile). The prompt could include a window, a GUI, or other symbolic graphical interface displayed on smartphone 10. The name of the business 30 is then displayed on the smartphone 10 in association with the window, GUI, or other symbolic graphical interface. When the GUI is “clicked” or selected, an interface specific to the target business 30 is shown, the interface allowing for the initiation and completion of a transaction. The interface may be translated into the native language of the smartphone user, with the application of the invention storing many languages to allow the system of the invention to be used in any country. For example, if the business 30 is a restaurant, a menu may be shown on display 14 (after clicking on e.g., the GUI prompt generated by computer 32) which menu may be iconic in nature, that is the menu may show food items and prices only. The user may then “click” on a food item to order it with display 14 showing the price and the selected food item. The user may then click on the displayed food item to complete the order using the interface provided by the business 32. It can be appreciated that the interface provided by the business 30 will vary greatly depending upon the type of business. Alternatively, a user may simply navigate to the website of the selected business 30 (in response to the prompt, and complete the order via the website provided by the business. In lieu of a menu driven interface, a GUI prompt displayed on the user device display 14 may initiate a text session, allowing the user to text an order to the restaurant interactively as explained in more detail below.

If several businesses are in proximity to the user as determined above, then all would be listed by way of prompts as discussed above, with the user selecting the desired business (if any) in the manner of the invention.

A transducer associated with computer 32 (which may be positioned remotely from the computer 32) may optionally output an audible spoken word version of the order. This capability would have to be provided by an application associated with the computer 32. The transducer, not shown, may be in the kitchen so that chefs can hear the order once it is completed. It is contemplated by the invention that a financial transaction may also be consummated when the order is completed, the transaction facilitated by the application software in the well known manner. The user may of course decline to place an order when prompted and then close the application. Since the above process of texting or otherwise initiating electronic communication with businesses 30 on a proximity basis can sometimes result in several businesses 30 prompting the user at once, the user can simply decline to place an order by closing the window associated with the prompt appearing on the smartphone 10 or by not responding at all and waiting for the prompt to “time out”.

In an alternative to the business computer 32 transmitting a GUI driven menu interface (in response to proximity), a text from the business 30, which may be translated from a language non-native to the user as discussed below, is sent to the smartphone 10 and the user and the selected business 30 may then engage in whatever dialogue, using text exchanges, is necessary to complete the order, even though the user and business proprietors do not speak the same language. The business 30 may text an invoice at the conclusion of the transaction, with the transaction concluded when payment is received from the user.

The text application is multi-functional in that it can not only convert text-to-speech and speech-to-text, but can also translate languages or symbols. Thus, a translation service is also contemplated. The processing for the translation may be conducted by the text application on the smartphone 10. As a non-limiting example, a user may input text in one language, which text may then be translated into another language, this being a capability commonly provided on smartphones. Thus, a deaf person traveling abroad may input a text message in one language on smartphone 10 and send the text message to a business 30, and have the text translated and output in a different language by the receiver, e.g., the business 30. The incoming text from the business 30 will be automatically translated into the language used by the smartphone user, i.e., the native language for the smartphone user. The order is then prepared based on the exchange of text messages so that the user need only pick up the order after presenting identifying information for visual inspection and verification on the smartphone 10 when at the restaurant 30. In this scenario, the hearing impaired user is spared the sometimes embarrassing situation of having to gesture or otherwise improvise their way through a commercial transaction.

In use, and by way of a non-limiting example, a search for a business 30 is initiated as described above. The user then selects a desired business 30 from the list resulting from the search. Communication with the restaurant 30 can commence when the user clicks on a GUI presented on display 14 in response to the user selection, the GUI causing an interface to appear or a text box to open. The user may then interact with the e.g., restaurant 30 to place an order. The text method described above allows for interaction between the user and e.g., a waiter, so that the order can be completed, and also allows for a high degree customizing the order as there is a real time interchange between user and restaurant staff using texts, as opposed to being constrained by an interactive menu offering discrete choices. The inventive application allows for translation of the text exchange as described above.

It is to be understood that the present invention is not limited to the sole embodiment described above, but encompasses any and all embodiments within the scope of the following claims:

I claim:

1. A method of conducting a transaction between a hearing impaired user using a GPS enabled first computing device and one or more participating businesses having a second computing device comprising the steps of:
loading text and translation applications onto both said first and second computing devices, said applications having a particular communication protocol, the text and translation application on said first computing device including stored address and GPS data for said businesses;
conducting a proximity search in real time for participating businesses;
prompting said user using said first computing device when the user is within a predetermined distance from any of said participating businesses, and initiating communication between said first and second computing devices.

2. The method of claim 1 wherein said first computing device is a smartphone, and said prompt is both audible and visual.

3. The method of claim 1 wherein said first computing device is a smartphone, and said prompt is tactile.

4. The method of claim 1 wherein prompting said user includes the step of transmitting a GUI from the second computing device to the first computing device.

5. The method of claim 4 including the step of providing an interface in response to a user selecting said GUI.

6. The method of claim 4 including the step of providing a text box in response to a user selecting said GUI.

7. The method of claim 6 wherein the text box is translated into the language of the user.

8. The method of claim 5 wherein the interface is translated into the language of the user.
